(19) United States
(12) Patent Application Publication
(10) Pub. No.: US 2025/0116784 A1
(43) Pub. Date: Apr. 10, 2025

(54) ASSURED POSITION, NAVIGATION, AND TIMING GNSS DENIED SOLUTION FOR A SATELLITE TERMINAL

(71) Applicant: Kymeta Corporation, Redmond, WA (US)

(72) Inventors: Alex Schnedler, Seattle, WA (US); Jeff Kissinger, Redmond, WA (US); Kevin KleinOsowski, Redmond, WA (US); Frank Armstrong, Redmond, WA (US); Ken Harp, Redmond, WA (US); Paul Klassen, Redmond, WA (US); Dane Perryman, Seattle, WA (US)

(21) Appl. No.: 18/905,485

(22) Filed: Oct. 3, 2024

Related U.S. Application Data
(60) Provisional application No. 63/543,012, filed on Oct. 6, 2023.

(51) Int. Cl. G01S 19/42; G01S 19/25; G01S 19/45

(52) U.S. Cl. CPC G01S 19/423; G01S 19/256; G01S 19/45

(57) ABSTRACT

A position, navigation, and timing (PNT) system, a satellite terminal and methods for using the same are disclosed. In some embodiments, the satellite terminal includes: a plurality of receivers operable to receive a plurality of constellation signals having position and navigation information; position and timing systems; and an embedded position, navigation and timing (PNT) system coupled to the position and timing systems, the PNT system operable to receive the constellation signals and provide a transcoder output signal to the position and timing systems.

### RELATED APPLICATION

The present application is a non-provisional application of and claims the benefit of U.S. Provisional Patent Application No. 63/543,012, filed Oct. 6, 2023, and entitled “ASSURED POSITION, NAVIGATION, AND TIMING GNSS DENIED SOLUTION FOR KYMETA SATELLITE TERMINAL”, which is incorporated by reference in its entirety.

### FIELD OF THE DISCLOSURE

Embodiments of the present disclosure are related to wireless communication; more particularly, embodiments disclosed herein related to a satellite device (e.g., terminal) having embedded position, navigation and timing (PNT) system.

### BACKGROUND

Position, velocity, and timing signals from a Global Positioning System (GPS) are used throughout the world. GPS often relies on the use of Global Navigation Satellite System (GNSS) signals. The GNSS signals are received by a receiver and then used to generate the position, velocity and timing signals. However, a receiver cannot provide those signals if the GNSS signals are not available to the receiver. The GNSS signals may not be available due to interference (e.g., jamming), spoofing, or signal blockage. This situation is often referred to as a GNSS denial situation or a GNSS degraded situation.

GNSS signals can undergo interference due to jamming. Jamming occurs if a signal is intentionally transmitted in the GNSS frequency range. In such a case, the interfering signal essentially overpowers the GNSS signal. Unlike interference where GNSS is denied by overpowering the GNSS signal, spoofing causes a receiver to report an incorrect location or time. In the GNSS context, spoofing can occur by broadcasting a signal with the same structure and frequency as the GNSS signal, which causes the receiver to lock onto the spoofed signal instead of the actual GNSS signal. The information in the spoofed signal is changed from that of the GNSS signal so that the receiver calculates an incorrect position or time. Lastly, if a GNSS receiver is blocked from receiving a GNSS signal, such as due to some form of obstruction (e.g., buildings, mountains, trees, etc.), then a signal blockage can occur. If any of the above situations occurs, then a GNSS denial situation or a GNSS degraded situation can exist.

### SUMMARY

A position, navigation, and timing (PNT) system, a satellite terminal and methods for using the same are disclosed. In some embodiments, the satellite terminal includes: a plurality of receivers operable to receive a plurality of constellation signals having position and navigation information; position and timing systems; and an embedded position, navigation and timing (PNT) system coupled to the position and timing systems, the PNT system operable to receive the constellation signals and provide a transcoder output signal to the position and timing systems.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 illustrates an exploded view of some embodiments of a flat-panel antenna.

FIG. 2 illustrates an example of a communication system that includes one or more antennas according to some embodiments.

FIG. 3 illustrates a portion of a satellite terminal having an assured position, navigation, and timing (APNT) system.

FIG. 4 illustrates an example of an APNT system that includes an input for location information from an external location and/or the antenna control unit (ACU).

FIG. 5 illustrates some embodiments of a process for generating a transcoder signal.

### DETAILED DESCRIPTION

In the following description, numerous details are set forth to provide a more thorough explanation of embodiments of the present disclosure. It will be apparent, however, to one skilled in the art, that the teachings disclosed herein may be practiced without these specific details. In other instances, well-known structures and devices are shown in block diagram form, rather than in detail, in order to avoid obscuring the present disclosure.

Embodiments disclosed herein include a system that allows a satellite terminal to operate in multiple Global Navigation Satellite System (GNSS) degraded or denied environments if or when a degraded or denied event takes place. In some embodiments, the satellite terminal is allowed to operate by leveraging different and unique satellite constellation position and navigation systems as well as a timing holdover subsystem while in the satellite communications (communicating with a constellation of satellites) or cellular communications mode (communications with ground-based or terrestrial cellular (e.g., an LTE network)), in any configuration multi- or singular-constellation or network including, but not limited to, LEO, MEO, GEO.

### Examples of Antenna Embodiments

The techniques described herein may be used with a variety of satellite antennas, for example, but not limited to, flat panel satellite antennas, phased array antenna, and electronically steered antennas, etc. Some embodiments of such flat panel antennas are disclosed herein. In some embodiments, the flat panel satellite antennas are part of a satellite terminal. The flat panel antennas include one or more arrays of antenna elements on an antenna aperture.

In some embodiments, the antenna aperture is a metasurface antenna aperture, such as, for example, the antenna apertures described below. In some embodiments, the antenna elements comprise radio-frequency (RF) radiating antenna elements. In some embodiments, the antenna elements include tunable devices to tune the antenna elements. Examples of such tunable devices include diodes and varactors such as, for example, described in U.S. Pat. No. 11,489,266, entitled “Metasurface Antennas Manufactured with Mass Transfer Technologies,” issued Nov. 1, 2022. In some other embodiments, the antenna elements comprise liquid crystal (LC)-based antenna elements, such as, for example, those disclosed in U.S. Pat. No. 9,887,456, entitled “Dynamic Polarization and Coupling Control from a Steerable Cylindrically Fed Holographic Antenna”, issued Feb. 6, 2018, or other RF radiating antenna elements. It should be appreciated that other tunable devices such as, for example, but not limited to, tunable capacitors, tunable capacitance dies, packaged dies, micro-electromechanical systems (MEMS) devices, or other tunable capacitance devices, could be placed into an antenna aperture or elsewhere in variations on the embodiments described herein.

Although embodiments in this disclosure may draw on some examples in communications, some embodiments could be implemented in various receiving, transmitting, and/or sensing or other similar applications. Some examples could include devices for radar, lidar, sensors and sensing device such as, but not limited to, those in autonomous vehicles applications, and any other applications that can take advantage of attributes of an active metasurface according to various disclosed and undisclosed embodiments of the present disclosure.

In some embodiments, the antenna aperture having the one or more arrays of antenna elements is comprised of multiple segments that are coupled together. In some embodiments, when coupled together, the combination of the segments form groups of antenna elements (e.g., closed rings of antenna elements concentric with respect to the antenna feed, etc.). For more information on antenna segments, see U.S. Pat. No. 9,887,455, entitled “Aperture Segmentation of a Cylindrical Feed Antenna”, issued Feb. 6, 2018.

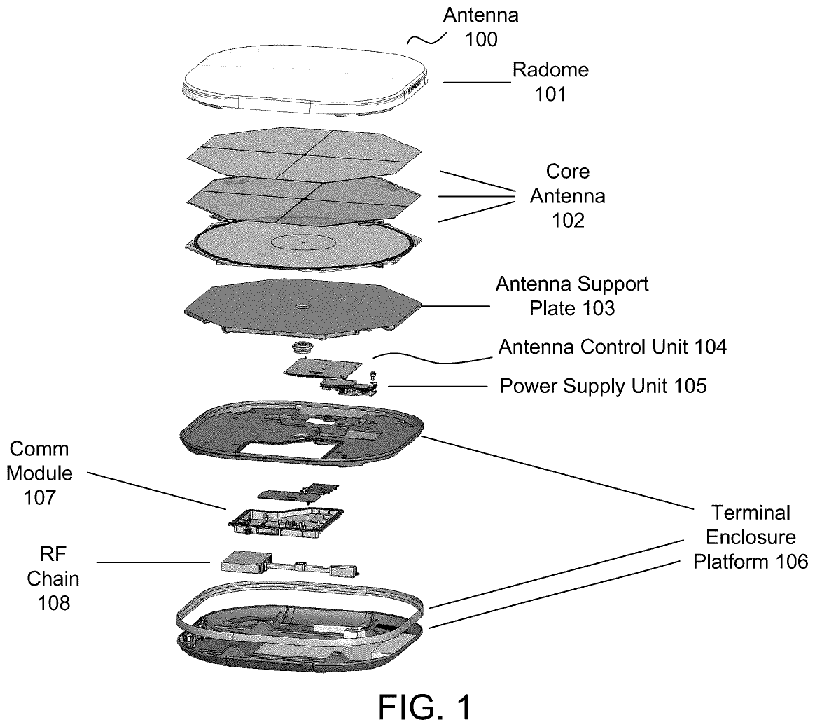

FIG. 1 illustrates an exploded view of some embodiments of a flat-panel antenna. Referring to FIG. 1, antenna 100 comprises a radome 101, a core antenna 102, antenna support plate 103, antenna control unit (ACU) 104, a power supply unit 105, terminal enclosure platform 106, comm (communication) module 107, and RF chain 108.

Radome 101 is the top portion of an enclosure that encloses core antenna 102. In some embodiments, radome 101 is weatherproof and is constructed of material transparent to radio waves to enable beams generated by core antenna 102 to extend to the exterior of radome 101.

In some embodiments, core antenna 102 comprises an aperture having RF radiating antenna elements. These antenna elements act as radiators (or slot radiators). In some embodiments, the antenna elements comprise scattering metamaterial antenna elements. In some embodiments, the antenna elements comprise both Receive (Rx) and Transmit (Tx) irises, or slots, that are interleaved and distributed on the whole surface of the antenna aperture of core antenna 102. Such Rx and Tx irises may be in groups of two or more sets where each set is for a separately and simultaneously controlled band. Examples of such antenna elements with irises are described in U.S. Pat. No. 10,892,553, entitled “Broad Tunable Bandwidth Radial Line Slot Antenna”, issued Jan. 12, 2021.

In some embodiments, the antenna elements comprise irises (iris openings) and the aperture antenna is used to generate a main beam shaped by using excitation from a cylindrical feed wave for radiating the iris openings through tunable elements (e.g., diodes, varactors, patch, etc.). In some embodiments, the antenna elements can be excited to radiate a horizontally or vertically polarized electric field at desired scan angles.

In some embodiments, a tunable element (e.g., diode, varactor, patch etc.) is located over each iris slot. The amount of radiated power from each antenna element is controlled by applying a voltage to the tunable element using a controller in ACU 104. Traces in core antenna 102 to each tunable element are used to provide the voltage to the tunable element. The voltage tunes or detunes the capacitance and thus the resonance frequency of individual elements to effectuate beam forming. The voltage required is dependent on the tunable element in use. Using this property, in some embodiments, the tunable element (e.g., diode, varactor, LC, etc.) integrates an on/off switch for the transmission of energy from a feed wave to the antenna element. When switched on, an antenna element emits an electromagnetic wave like an electrically small dipole antenna. Note that the teachings herein are not limited to having unit cell that operates in a binary fashion with respect to energy transmission. For example, in some embodiments in which varactors are the tunable element, there are 32 tuning levels. As another example, in some embodiments in which LC is the tunable element, there are 16 tuning levels.

A voltage between the tunable element and the slot can be modulated to tune the antenna element (e.g., the tunable resonator/slot). Adjusting the voltage varies the capacitance of a slot (e.g., the tunable resonator/slot). Accordingly, the reactance of a slot (e.g., the tunable resonator/slot) can be varied by changing the capacitance. Resonant frequency of the slot also changes according to the equation

$$f = \frac{1}{2 π \sqrt{LC}}$$

where f is the resonant frequency of the slot and L and C are the inductance and capacitance of the slot, respectively. The resonant frequency of the slot affects the energy coupled from a feed wave propagating through the waveguide to the antenna elements.

In particular, the generation of a focused beam by the metamaterial array of antenna elements can be explained by the phenomenon of constructive and destructive interference, which is well known in the art. Individual electromagnetic waves sum up (constructive interference) if they have the same phase when they meet in free space to create a beam, and waves cancel each other (destructive interference) if they are in opposite phase when they meet in free space. If the slots in core antenna 102 are positioned so that each successive slot is positioned at a different distance from the excitation point of the feed wave, the scattered wave from that antenna element will have a different phase than the scattered wave of the previous slot. In some embodiments, if the slots are spaced one quarter of a wavelength apart, each slot will scatter a wave with a one fourth phase delay from the previous slot. In some embodiments, by controlling which antenna elements are turned on or off (i.e., by changing the pattern of which antenna elements are turned on and which antenna elements are turned off) or which of the multiple tuning levels is used, a different pattern of constructive and destructive interference can be produced, and the antenna can change the direction of its beam(s).

In some embodiments, core antenna 102 includes a coaxial feed that is used to provide a cylindrical wave feed via an input feed, such as, for example, described in U.S. Pat. No. 9,887,456, entitled “Dynamic Polarization and Coupling Control from a Steerable Cylindrically Fed Holographic Antenna”, issued Feb. 6, 2018 or in U.S. Pat. No. 11,489,266, entitled “Metasurface Antennas Manufactured with Mass Transfer Technologies,” issued Nov. 1, 2022. In some embodiments, the cylindrical wave feed feeds core antenna 102 from a central point with an excitation that spreads outward in a cylindrical manner from the feed point. In other words, the cylindrically fed wave is an outward travelling concentric feed wave. Even so, the shape of the cylindrical feed antenna around the cylindrical feed can be circular, square or any shape. In some other embodiments, a cylindrically fed antenna aperture creates an inward travelling feed wave. In such a case, the feed wave most naturally comes from a circular structure.

In some embodiments, the core antenna comprises multiple layers. These layers include the one or more substrate layers forming the RF radiating antenna elements. In some embodiments, these layers may also include impedance matching layers (e.g., a wide-angle impedance matching (WAIM) layer, etc.), one or more spacer layers and/or dielectric layers. Such layers are well-known in the art.

Antenna support plate 103 is coupled to core antenna 102 to provide support for core antenna 102. In some embodiments, antenna support plate 103 includes one or more waveguides and one or more antenna feeds to provide one or more feed waves to core antenna 102 for use by antenna elements of core antenna 102 to generate one or more beams.

ACU 104 is coupled to antenna support plate 103 and provides controls for antenna 100. In some embodiments, these controls include controls for drive electronics for antenna 100 and a matrix drive circuitry to control a switching array interspersed throughout the array of RF radiating antenna elements. In some embodiments, the matrix drive circuitry uses unique addresses to apply voltages onto the tunable elements of the antenna elements to drive each antenna element separately from the other antenna elements. In some embodiments, the drive electronics for ACU 104 comprise commercial off-the shelf LCD controls used in commercial television appliances that adjust the voltage for each antenna element.

More specifically, in some embodiments, ACU 104 supplies an array of voltage signals to the tunable devices of the antenna elements to create a modulation, or control, pattern. The control pattern causes the elements to be tuned to different states. In some embodiments, ACU 104 uses the control pattern to control which antenna elements are turned on or off (or which of the tuning levels is used) and at which phase and amplitude level at the frequency of operation. The elements are selectively detuned for frequency operation by voltage application. In some embodiments, multistate control is used in which various elements are turned on and off to varying levels, further approximating a sinusoidal control pattern, as opposed to a square wave (i.e., a sinusoid gray shade modulation pattern).

In some embodiments, ACU 104 also contains one or more processors executing the software to perform some of the control operations. ACU 104 may control one or more sensors (e.g., a GPS receiver, a three-axis compass, a 3-axis accelerometer, 3-axis gyro, 3-axis magnetometer, etc.) to provide location and orientation information to the processor(s). The location and orientation information may be provided to the processor(s) by other systems in the earth station and/or may not be part of the antenna system.

Antenna 100 also includes a comm (communication) module 107 and an RF chain 108. Comm module 107 includes one or more modems enabling antenna 100 to communicate with various satellites and/or cellular systems, in addition to a router that selects the appropriate network route based on metrics (e.g., quality of service (QoS) metrics, e.g., signal strength, latency, etc.). RF chain 108 converts analog RF signals to digital form. In some embodiments, RF chain 108 comprises electronic components that may include amplifiers, filters, mixers, attenuators, and detectors.

Antenna 100 also includes power supply unit 105 to provide power to various subsystems or parts of antenna 100. Antenna 100 also includes terminal enclosure platform 106 that forms the enclosure for the bottom of antenna 100. In some embodiments, terminal enclosure platform 106 comprises multiple parts that are coupled to other parts of antenna 100, including radome 101, to enclose core antenna 102.

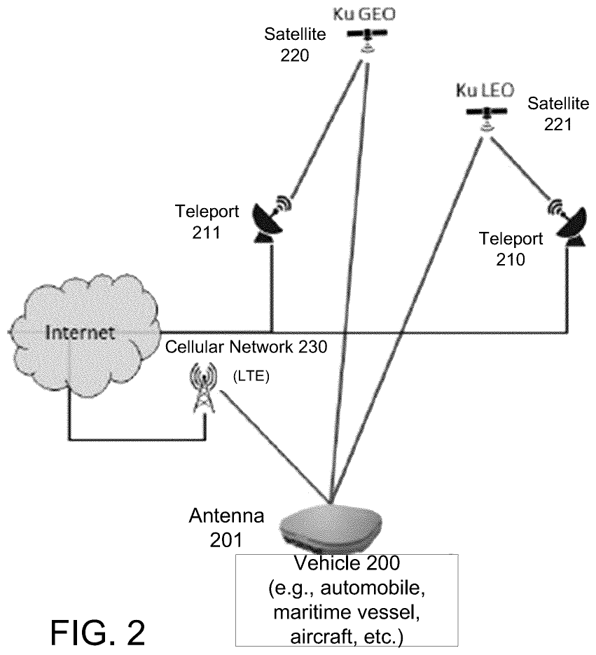

FIG. 2 illustrates an example of a communication system that includes one or more antennas described herein. Referring to FIG. 2, vehicle 200 includes an antenna 201. In some embodiments, antenna 201 comprises antenna 100 of FIG. 1. In some embodiments, vehicle 200 may comprise any one of several vehicles, such as, for example, but not limited to, an automobile (e.g., car, truck, bus, etc.), a maritime vehicle (e.g., boat, ship, etc.), airplanes (e.g., passenger jets, military jets, small craft planes, etc.), etc. Antenna 201 may be used to communicate while vehicle 200 is either on-the-pause or moving. Antenna 201 may be used to communicate to fixed locations as well, e.g., remote industrial sites (mining, oil, and gas) and/or remote renewable energy sites (solar farms, windfarms, etc.).

In some embodiments, antenna 201 is able to communicate with one or more communication infrastructures (e.g., satellite, cellular, networks (e.g., the Internet), etc.). For example, in some embodiments, antenna 201 is able to communication with satellites 220 (e.g., a GEO satellite) and 221 (e.g., a LEO satellite), cellular network 230 (e.g., an LTE, etc.), as well as network infrastructures (e.g., edge routers, Internet, etc.). For example, in some embodiments, antenna 201 comprises one or more satellite modems (e.g., a GEO modem, a LEO modem, etc.) to enable communication with various satellites such as satellite 220 (e.g., a GEO satellite) and satellite 221 (e.g., a LEO satellite) and one or more cellular modems to communicate with cellular network 230. For another example of an antenna communicating with one or more communication infrastructures, see U.S. Pat. No. 11,818,606, entitled “Multiple Aspects of Communication in a Diverse Communication Network”, and issued Nov. 14, 2023.

In some embodiments, to facilitate communication with various satellites, antenna 201 performs dynamic beam steering. In such a case, antenna 201 is able to dynamically change the direction of a beam that it generates to facilitate communication with different satellites. In some embodiments, antenna 201 includes multi-beam beam steering that allows antenna 201 to generate two or more beams at the same time, thereby enabling antenna 201 to communication with more than one satellite at the same time. Such functionality is often used when switching between satellites (e.g., performing a handover). For example, in some embodiments, antenna 201 generates and uses a first beam for communicating with satellite 220 and generates a second beam simultaneously to establish communication with satellite 221. After establishing communication with satellite 221, antenna 201 stops generating the first beam to end communication with satellite 220 while switching over to communicate with satellite 221 using the second beam. For more information on multi-beam communication, see U.S. Pat. No. 11,063,661, entitled “Beam Splitting Hand Off Systems Architecture”, issued Jul. 13, 2021.

In some embodiments, antenna 201 uses path diversity to enable a communication session that is occurring with one communication path (e.g., satellite, cellular, etc.) to continue during and after a handover with another communication path (e.g., a different satellite, a different cellular system, etc.). For example, if antenna 201 is in communication with satellite 220 and switches to satellite 221 by dynamically changing its beam direction, its session with satellite 220 is combined with the session occurring with satellite 221.

Thus, the antennas described herein may be part of a satellite terminal that enables ubiquitous communications and multiple different communication connections. In some embodiments, antenna 201 comprises a metasurface RF antenna having multiple RF radiating antenna elements that are tuned to desired frequencies using RF antenna element drive circuitry. The drive circuitry can include a drive transistor (e.g., a thin film transistor (TFT) (e.g., CMOS, NMOS, etc.), low or high temperature polysilicon transistor, memristor, etc.), a Microelectromechanical systems (MEMS) circuit, or other circuit for driving a voltage to an RF radiating antenna element. In some embodiments, the drive circuitry comprises an active-matrix drive. In some embodiments, the frequency of each antenna element is controlled by an applied voltage. In some embodiments, this applied voltage is also stored in each antenna element (pixel circuit) until the next voltage writing cycle.

### Assured Position, Navigation, and Timing GNSS Denied Solution for a Satellite Terminal

Embodiments disclosed herein include a system that allows a satellite terminal to operate in multiple Global Navigation Satellite System (GNSS) degraded or denied environments. Techniques disclosed herein allow multiple satellite position and navigation receivers to operate within a single terminal environment without interaction from an outside user by leveraging circuitry, logic and/or algorithms within the system to continuously provide the modems and antenna systems with multi-constellation position and navigation sources to enable timing and position while in network (e.g., LEO, MEO, GEO) mode.

Techniques disclosed herein allow operation of a satellite terminal in a GNSS degraded or denied environment regardless of the terminal's constellation mode. In some embodiments, the satellite terminal has a fully integrated PNT (Position Navigation and Timing) system (e.g., Assured Position Navigation and Timing (APNT) system). By being fully integrated, the satellite terminal does not require input from an external PNT system to operate with LEO and GEO satellite constellations in a GNSS denied or GNSS degraded environment (as opposed to being unable to operate).

In some embodiments, the integrated technology of the APNT system includes a timing holdover subsystem for holdover timing accuracy requirements of modern GPS synchronized network constellations. In some embodiments, the integrated timing holdover subsystem includes long duration support for GNSS denied or degraded environments.

In some embodiments, the APNT system enables onboard position and timing systems to receive updates from a trusted source or a single source of truth. In some embodiments, the APNT receives multiple signals using multiple receivers (with an associated antenna) and provides a single output signal (e.g., a single transcoded output signal) to onboard position and timing systems (e.g., modem and GPS receiver in the ACU, a LEO modem and GPS receiver for a LEO satellite constellation, a GEO modem and GPS receiver for a GEO satellite constellation etc.). More specifically, in some embodiments, the satellite terminal receives GNSS position and timing information from various unique position and navigation satellite constellations and generates a single output signal in response to the GNSS position and timing information. Combining multiple receivers into a single package enhances the satellite terminal's ability to receive constellation signals from multiple position and navigation constellations and reduces the number of product variants. In some embodiments, the single output signal is based on what the APNT system determines to be the optimized, best and/or strongest signal and thus become the trusted source or the single source of truth. In some embodiments, the output signal is sent to split signal architecture that supplies a copy of the signal to the rest of the onboard position and timing systems for use therein.

Techniques and/or embodiments disclosed herein or within the scope of the present disclosure enable a satellite terminal to receive, evaluate, and switch between unique LEO, MEO, and GEO position and navigation constellations that use various frequency bands to provide position and timing to the terminal's GNSS systems. When the timing signal is received and a constellation handoff is correctly performed, the satellite terminal will not interpret an interruption and will not incur downtime between satellites in the LEO, MEO, or GEO modes, respectively, and network switching.

In some embodiments, the APNT system is integrated into a satellite terminal and utilizes onboard GNSS antennas to provide position and timing to the terminal's onboard systems without requiring additional external input sources. In some embodiments, an APNT system can detect and mitigate multiple GNSS degraded, denied, or location spoofing situations for a period of time (e.g., up to 12 hours or longer) without an external input. In some embodiments, the terminal operates in environments where position and navigation would be degraded or denied compared to using traditional GNSS constellation, without requiring user intervention and/or monitoring.

In some embodiments, the techniques disclosed herein provide for an embedded/integrated solution, providing for a more compact form factor and rugged product, in contrast to using an external module. In some embodiments, one common GNSS antenna is used, reducing and mitigating excess parts, cost, and weight associated with using separate antennas for each receiver type. In some embodiments using two or more GNSS receivers to obtain multiple GNSS signals, the two or more GNSS receivers can use the same antenna.

In some embodiments, the APNT system includes a substrate (e.g., a PCB board) with multi-constellation receiver support and hold-over capability that contributes position and timing to an on-board splitter that is coupled (e.g., via cabling) to a modem support module (e.g., EGR (Embedded GNSS Receiver)) and an antenna control unit (ACU).

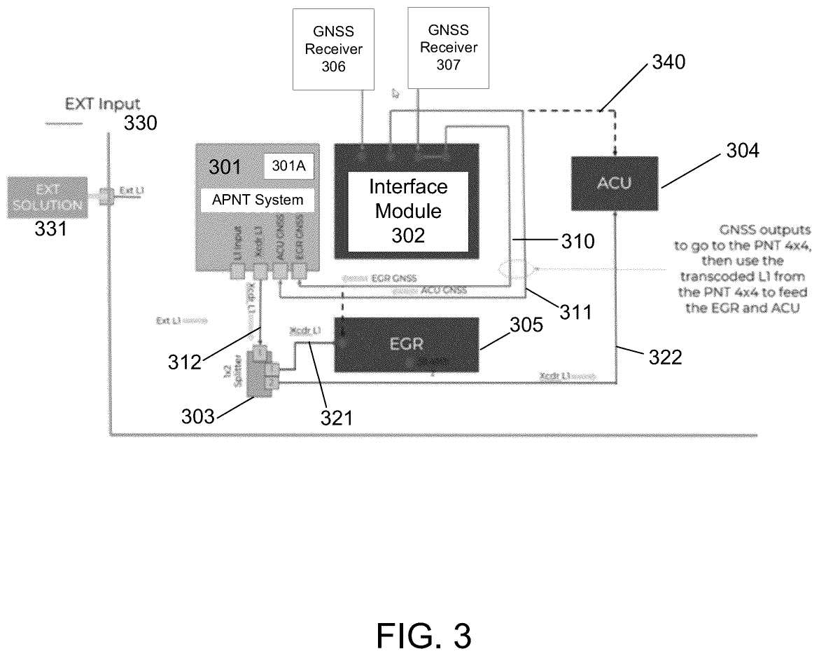

FIG. 3 illustrates a portion of a satellite terminal having an APNT system, referred to as a PNT solution. Referring to FIG. 3, a portion of the satellite terminal is shown having an APNT system 301, a military OneWeb Interface Module (mOIM) or other interface module 302, splitter 303, ACU 304, and a modem support module, referred to as EGR 305, along with GNSS receivers (with associated antenna) 306 and 307. In some other embodiments, the interface module 302 can be part of ACU 304.

In some embodiments, an RF signal input to the APNT system 301 originates from an interface module 302. GNSS receivers 306 and 307 receive and provide constellation signals, GNSS signals, to the interface module 302. In some embodiments, both GNSS signals are duplicated using a splitter in interface module 302, and after the splitter, one branch of each signal goes to an onboard RTK GNSS receiver while the other branch is passed through as EGR GNSS signal 310 and ACU GNSS signal 311 to the APNT system 301. In some embodiments, GNSS signals 310 and 311 proceed downstream from interface module 302 to inputs of the APNT system 301. In some embodiments, the interface module 302 receives multiple GNSS signals and provides only a single GNSS signal to the APNT system 301.

In response to GNSS signals 310 and 311 signals, the APNT system 301, via use of an onboard position and timing signal transcoder 301A, outputs the reference signal (transcoded output signal 312) to the embedded signal splitter 303 to be directed to the onboard position and timing systems, such as EGR 305 (e.g., LEO modem and GNSS receiver) and the onboard position and timing system in or coupled to ACU 304 (e.g., the antenna control unit modem and GNSS receiver). In some embodiments, the GNSS receivers of EGR 305 and the onboard position and timing system in or coupled to ACU 304 receive GPS in addition to other Global Navigation Satellite Systems such as Galileo and GLONASS. The RF chains in the onboard position and timing systems use the timing and location information in the transcoded signal for satellite communication.

In some embodiments, position and navigation constellation signals could come from GNSS constellations comprising, for example, but not limited to: GPS (US MEO), BEIDOU (China), GALILEO (EU), and GLONASS (Russia), as well as Satelles (Iridium LEO) and Mosaic (Inmarsat GEO), and a backup oscillator comprising of either OCXO, Rubidium, or Cesium clocks.

In some embodiments, the satellite terminal allows the use of an external GNSS system to provide the location information to the ACU while the system is in holdover mode (e.g., GNSS Denied). For example, external input 330 or an external solution 331 can provide location information. In such a case, in some embodiments, the timing is provided by the backup oscillator. If all of the GNSS receivers are jammed, blocked, spoofed, or degraded, then the oscillator continues to provide timing into the system. In some embodiments, the externally provided location or an ACU INS (Inertial Navigation System) along with the timing from the oscillator are provided to the APNT system and used by the onboard position and timing signal transcoder to generate the single output signal that is sent to the onboard position and timing systems (via the splitter system). In some embodiments, the ACU INS position is derived position from communication satellite angle of arrival on the beam to which the satellite terminal is locked. Therefore, some embodiments include the integration of the satellite beam angle of arrival for the position in holdover, paired with the holdover clock (e.g., backup oscillator), for precise timing while moving or stationary. In this way, the satellite terminal can handle communications, including communications on the pause (COTP/COTH) or communications on the move (COTM), during handover.

In some embodiments, during normal operating mode, the APNT system 301 includes a substrate (e.g., PCB) that receives GNSS RF signals from the interface module 302. In some embodiments, the APNT system 301 includes multiple receivers. In some embodiments, a first receiver detects if a signal becomes degraded or if the signal is no longer being received, a second receiver (e.g., a Satellite Time and Location (STL) receiver) determines if it is being spoofed or jammed.

In some embodiments, the APNT's onboard satellite position and timing receivers process and provide a primary reference source (PRS) output (e.g., a Layer 1 (L1) signal output 3, a Layer 5 (L5) signal output, etc.) to the APNT system's RF signal transcoder 301A. The onboard position and timing signal transcoder 301A evaluates these L1 signals based on a number of performance indicators (e.g., SNR and/or other metrics), and the best choice signal will be the transcoder L1 output. The APNT system 301 sends this transcoder L1 output 312 to the embedded splitter 303 (e.g., embedded 1×2 splitter) where the RF signal is split (e.g., duplicated) to the embedded GPS receiver (EGR 305) for LEO modem support and the ACU 304 for LEO and GEO mode support. If the onboard receiver signals stop or are denied, the onboard backup oscillator will provide timing to the system.

In some other embodiments, the APNT system 301 receives one or more GNSS signal from interface module 302 and an STL signal from an STL receiver. In this case, the onboard position and timing signal transcoder 301A evaluates these signals and determines which to use as the transcoder L1 output. This evaluation can be based on whether the onboard receiver signals stop or are denied (e.g., the interference from jamming and/or whether spoofing is occurring).

Integration of the fully GNSS denied solution in both long and short holdover (for long and short outages, respectively) with highly precise timing into a multi-network and multi-constellation user terminal enables high availability communications across the network without loss of connection due to time synchronization.

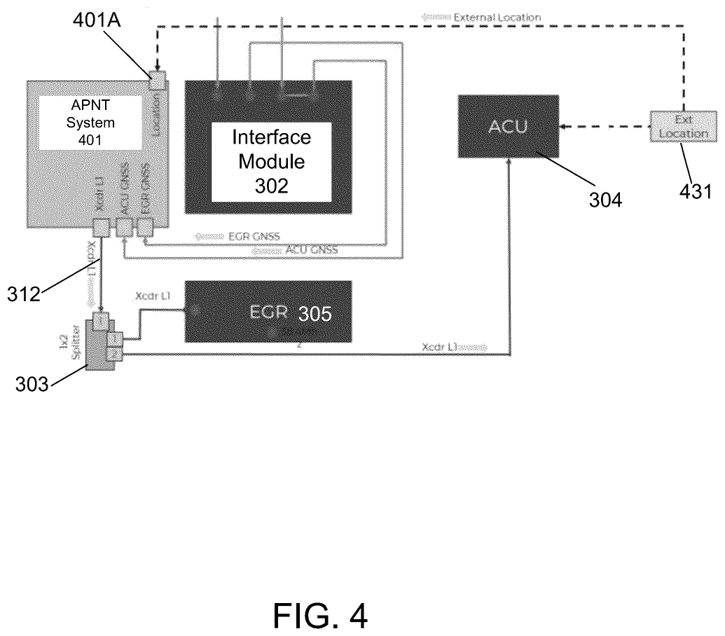

In some embodiments, the APNT system includes an input for location information from an external location and/or the ACU. This location information can be needed at times where the APNT system has good timing reference (e.g., because it's running on its atomic clock or its controlled crystal oscillator), but does not have information indicating the location of the satellite terminal. For example, if the clock is disciplined (resynced to a reference (e.g., a previously received satellite signal)), the satellite terminal is in a jamming or spoofing scenario and the terminal moves more than a couple kilometers, which is the required locational accuracy for a satellite service (e.g., the OneWeb service), then the APNT system doesn't know where it's located, information is provided into the APNT system that then transcodes into that that PRS (e.g., GPS) signal (e.g., a transcoded output signal on the L1 signal path). Similarly, in some embodiments, if access to STL or GNSS is not available, information is provided into the APNT system that then transcodes into that PRS (e.g., GPS) signal. Because the ACU has a number of different sources for location information including user input, the location information can be obtained by the ACU from other external devices and provided to the APNT system. Such an arrangement is shown in FIG. 4.

Referring to FIG. 4, the APNT system 401, which processes GNSS signals in the same manner as the APNT system 301 in FIG. 3, includes an input 401A to receive location information from an external source referred to as external location 431. In some embodiments, the location information from external location 431 is also provided to ACU 304. As stated above, in some embodiments, the location information is used during holdover mode.

In some other embodiments, the location information can be determined by the APNT system by a OneWeb (or other service's) satellite signal, angle of arrival, which are used to triangulate or calculate where the satellite terminal is located on Earth.

Thus, in some embodiments, location information is fed to and for use by the APNT system in generating an L1 transcoded output signal in addition to its clock when it's in a holdover mode.

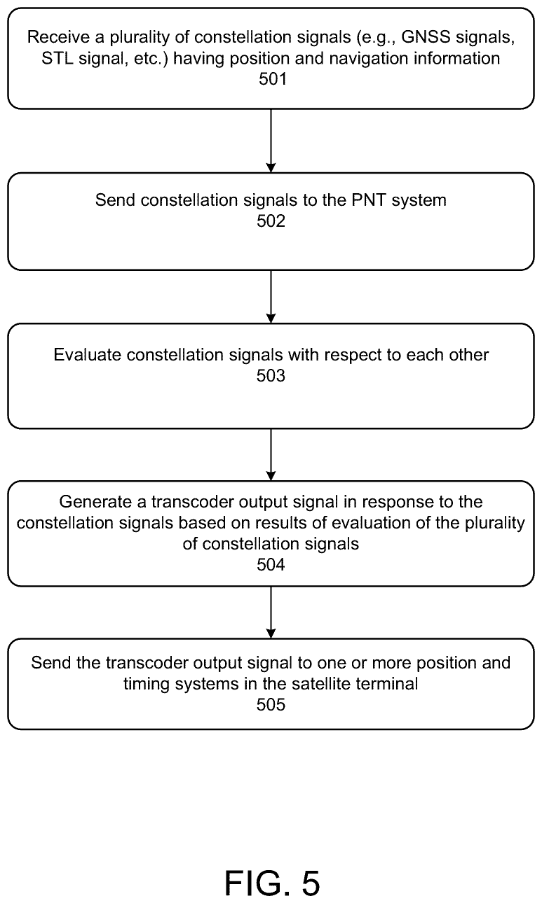

FIG. 5 illustrates some embodiments of a process or a method for generating a transcoder signal. The process is performed by processing logic that may comprise hardware (circuitry, dedicated logic, etc.), software (such as is run on a general-purpose computer system or a dedicated machine), firmware, or a combination of the three. In some embodiments, the process is performed by a satellite terminal having an embedded position, navigation and timing (PNT) (e.g., an assured PNT (APNT)) system and multiple receivers for receiving constellation signals.

Referring to FIG. 5, the process includes processing logic receiving, by multiple receivers, a plurality of constellation signals having position and navigation information (processing block 501). In some embodiments, the constellation signals are received by multiple receivers (with antennas) in the satellite terminal. In some embodiments, the constellation signals include one or more GNSS signals (e.g., two GNSS signals, three GNSS signals, etc.) and are received by one or more GNSS receivers of the satellite terminal. In some embodiments, the constellation signals include a Satellite Time and Location (STL) signal received by an STL receiver of the satellite terminal.

Processing logic sending constellation signals to the PNT system (processing block 502), and the PNT system evaluates them with respect to each other (processing block 503). In some embodiments, the PNT system determines which of the constellation signals is a better (e.g., more reliable). For example, when a first GNSS receiver receives a first GNSS signal and a STL receiver receives an STL signal, the PNT system evaluates the first GNSS signal and the STL signal against each other. Similarly, when any number (e.g., two, three, etc.) of GNSS receivers receive GNSS signals and a STL receiver receives an STL signal, the PNT system receives a single GNSS signal generated based on the two or more GNSS signals and evaluates that single GNSS signal and the STL signal against each other.

Processing logic generates a transcoder output signal in response to the constellation signals based on results of evaluation of the plurality of constellation signals (processing block 504). In some embodiments, the processing logic is part of the PNT system. In some embodiments, the transcoder output signal comprises a transcoder Layer 1 (L1) output signal. In some embodiments, if the PNT system generates the transcoder output system using either the GNSS signal or the STL signal based on determining, as part of its evaluation process, which is a better signal.

In some embodiments, processing logic generates the transcoder output signal based on a clock (e.g., an on-board oscillator) instead of any constellation signals (e.g., instead of a GNSS signal or STL signal). The clock can come from the ACU. This use of the clock can occur during a holdover mode.

Processing logic sends the transcoder output signal to one or more position and timing systems in the satellite terminal (processing block 505). In some embodiments, one of the on-board position and timing systems is part of an ACU of the satellite terminal that includes a GPS receiver that uses information from the transcoder output signal. In some embodiments, another of the on-board position and timing systems includes a LEO modem that requires a GNSS input. In some embodiments, processing logic sends the transcoder output signal to a splitter from which the transcoder output signal proceeds to two or more position and timing systems (e.g., a GPS receiver in the ACU, a LEO modem that requires a GNSS input, etc.).

There is a number of example embodiments described herein.

Example 1 is a satellite terminal including: a plurality of receivers operable to receive a plurality of constellation signals having position and navigation information; position and timing systems; and an embedded position, navigation and timing (PNT) system coupled to the position and timing systems, the PNT system operable to receive the constellation signals and provide a transcoder output signal to the position and timing systems.

Example 2 is the satellite terminal of example 1 that may optionally include that the PNT includes a position and timing signal transcoder to evaluate the plurality of constellation signals and generate the transcoder output signal in response to the constellation signals based on results of evaluation of the plurality of constellation signals.

Example 3 is the satellite terminal of example 2 that may optionally include that the transcoder output signal comprises a transcoder Layer 1 (L1) or Layer 5 (L5) output signal.

Example 4 is the satellite terminal of example 1 that may optionally include that at least one of the receivers of the plurality of the receivers is a Global Navigation Satellite System (GNSS) receiver operable to receive a GNSS signal.

Example 5 is the satellite terminal of example 4 that may optionally include that the plurality of receivers comprises a plurality of GNSS receivers operable to receive a plurality of GNSS position and timing signals from a plurality of position and navigation satellite constellations.

Example 6 is the satellite terminal of example 5 that may optionally include that at least one of the receivers of the plurality of the receivers is a Satellite Time and Location (STL) receiver operable to receive an STL signal.

Example 7 is the satellite terminal of example 1 that may optionally include that one of the position and timing systems is coupled to an antenna control unit (ACU) that includes a GPS receiver that uses information from the transcoder output signal.

Example 8 is the satellite terminal of example 7 that may optionally include that one of the position and timing systems includes a LEO modem that requires a GNSS input.

Example 9 is the satellite terminal of example 8 that may optionally include a splitter coupled to the PNT system and configured to provide the transcoder output signal to the GPS receiver in the ACU and the LEO modem.

Example 10 is the satellite terminal of example 1 that may optionally include that the PNT system includes a location input to receive location information.

Example 11 is the satellite terminal of example 10 that may optionally include that the PNT system is configured to receive the location information during holdover from the ACU, which is created based on angle of arrival and direction from a satellite and the location of one or more the satellites.

Example 12 is the satellite terminal of example 11 that may optionally include that the PNT system uses a clock signal from a backup oscillator to determine the transcoder output signal during holdover mode.

Example 13 is the satellite terminal of example 11 that may optionally include an external input coupled to the PNT to receive the location information from an external source.

Example 14 is a method executable by a satellite terminal having an embedded position, navigation and timing (PNT) system and a plurality of receivers, the method including: receiving, by the plurality of receivers, a plurality of constellation signals having position and navigation information; sending the plurality of constellation signals to the PNT system; evaluating, by a position and timing signal transcoder in the PNT system, the plurality of constellation signals; and generating, by the PNT system, a transcoder output signal to a plurality of position and timing systems in the satellite terminal in response to the constellation signals based on results of evaluation of the plurality of constellation signals.

Example 15 is the method of example 14 that may optionally include that the transcoder output signal comprises a transcoder Layer 1 (L1) or Layer 5 (L5) output signal.

Example 16 is the method of example 15 that may optionally include that receiving the plurality of constellation signals having position and navigation information includes: receiving a first GNSS signal via a first Global Navigation Satellite System (GNSS) receiver of the plurality of the receivers; and receiving an STL signal via a Satellite Time and Location (STL) receiver of the plurality of the receivers; wherein evaluating the plurality of constellation signals comprises evaluating the first GNSS signal and the STL signal against each other.

Example 16 is the method of example 16 that may optionally include receiving a clock signal from a backup oscillator wherein receiving the plurality of constellation signals having position and navigation information further comprises receiving a second GNSS signal via a second Global Navigation Satellite System (GNSS) receiver of the plurality of the receivers; and generating a single GNSS signal from the first and second GNSS signals; wherein: evaluating the plurality of constellation signals comprises evaluating the single GNSS signal and the STL signal against each other, and generating the transcoder output signal to the plurality of position and timing systems in the satellite terminal in response to the constellation signals is based on the clock signal and evaluating the single GNSS signal and the STL signal against each other.

Example 18 is the method of example 14 that may optionally include that a first of the position and timing systems is part of an antenna control unit (ACU) of the satellite terminal that includes a GNSS receiver that uses information from the transcoder output signal.

Example 19 is the method of example 18 that may optionally include that a second of the position and timing systems includes a LEO modem that requires a GNSS input.

Example 20 is the method of example 18 that may optionally include sending, using a splitter coupled to the PNT system, the transcoder output signal, to GNSS receiver in the ACU and the LEO modem.

Methods and tasks described herein may be performed and fully automated by a computer system. The computer system may, in some cases, include multiple distinct computers or computing devices (e.g., physical servers, workstations, storage arrays, cloud computing resources, etc.) that communicate and interoperate over a network to perform the described functions. Each such computing device typically includes a processor (or multiple processors) that executes program instructions or modules stored in a memory or other non-transitory computer-readable storage medium or device (e.g., solid state storage devices, disk drives, etc.). The various functions disclosed herein may be embodied in such program instructions, or may be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid-state memory chips or magnetic disks, into a different state. In some embodiments, the computer system may be a cloud-based computing system whose processing resources are shared by multiple distinct business entities or other users.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware (e.g., ASICs or FPGA devices), computer software that runs on computer hardware, or combinations of both. Moreover, the various illustrative logical blocks and modules described in connection with the embodiments disclosed herein can be implemented or performed by a machine, such as a processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the rendering techniques described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements or steps. Thus, such conditional language is not generally intended to imply that features, elements or steps are in any way required for one or more embodiments or that one or more embodiments necessarily include logic for deciding, with or without other input or prompting, whether these features, elements or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, or Z). Thus, such disjunctive language is not generally intended to, and should not, imply that certain embodiments require at least one of X, at least one of Y, and at least one of Z to each be present.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

1. A satellite terminal comprising:
a plurality of receivers operable to receive a plurality of constellation signals having position and navigation information;
position and timing systems; and
an embedded position, navigation and timing (PNT) system coupled to the position and timing systems, the PNT system operable to receive the constellation signals and provide a transcoder output signal to the position and timing systems.

2. The satellite terminal of claim 1 wherein the PNT includes a position and timing signal transcoder to evaluate the plurality of constellation signals and generate the transcoder output signal in response to the constellation signals based on results of evaluation of the plurality of constellation signals.

3. The satellite terminal of claim 2 wherein the transcoder output signal comprises a transcoder Layer 1 (L1) or Layer 5 (L5) output signal.

4. The satellite terminal of claim 1 wherein at least one of the receivers of the plurality of the receivers is a Global Navigation Satellite System (GNSS) receiver operable to receive a GNSS signal.

5. The satellite terminal of claim 4 wherein the plurality of receivers comprises a plurality of GNSS receivers operable to receive a plurality of GNSS position and timing signals from a plurality of position and navigation satellite constellations.

6. The satellite terminal of claim 5 wherein at least one of the receivers of the plurality of the receivers is a Satellite Time and Location (STL) receiver operable to receive an STL signal.

7. The satellite terminal of claim 1 wherein one of the position and timing systems is coupled to an antenna control unit (ACU) that includes a GPS receiver that uses information from the transcoder output signal.

8. The satellite terminal of claim 7 wherein one of the position and timing systems includes a LEO modem that requires a GNSS input.

9. The satellite terminal of claim 8 further comprising a splitter coupled to the PNT system and configured to provide the transcoder output signal to the GPS receiver in the ACU and the LEO modem.

10. The satellite terminal of claim 1 wherein the PNT system includes a location input to receive location information.

11. The satellite terminal of claim 10 wherein the PNT system is configured to receive the location information during holdover from the ACU, which is created based on angle of arrival and direction from a satellite and the location of one or more the satellites.

12. The satellite terminal of claim 11 wherein the PNT system uses a clock signal from a backup oscillator to determine the transcoder output signal during holdover mode.

13. The satellite terminal of claim 11 further comprising an external input coupled to the PNT to receive the location information from an external source.

14. A method executable by a satellite terminal having an embedded position, navigation and timing (PNT) system and a plurality of receivers, the method comprising:
receiving, by the plurality of receivers, a plurality of constellation signals having position and navigation information;
sending the plurality of constellation signals to the PNT system;
evaluating, by a position and timing signal transcoder in the PNT system, the plurality of constellation signals; and
generating, by the PNT system, a transcoder output signal to a plurality of position and timing systems in the satellite terminal in response to the constellation signals based on results of evaluation of the plurality of constellation signals.

15. The method of claim 14 wherein the transcoder output signal comprises a transcoder Layer 1 (L1) or Layer 5 (L5) output signal.

16. The method of claim 15 wherein receiving the plurality of constellation signals having position and navigation information comprises:
receiving a first GNSS signal via a first Global Navigation Satellite System (GNSS) receiver of the plurality of the receivers; and
receiving an STL signal via a Satellite Time and Location (STL) receiver of the plurality of the receivers;
wherein evaluating the plurality of constellation signals comprises evaluating the first GNSS signal and the STL signal against each other.

17. The method of claim 16 further comprising:
receiving a clock signal from a backup oscillator wherein receiving the plurality of constellation signals having position and navigation information further comprises receiving a second GNSS signal via a second Global Navigation Satellite System (GNSS) receiver of the plurality of the receivers; and
generating a single GNSS signal from the first and second GNSS signals;
wherein:
evaluating the plurality of constellation signals comprises evaluating the single GNSS signal and the STL signal against each other, and
generating the transcoder output signal to the plurality of position and timing systems in the satellite terminal in response to the constellation signals is based on the clock signal and evaluating the single GNSS signal and the STL signal against each other.

18. The method of claim 14 wherein a first of the position and timing systems is part of an antenna control unit (ACU) of the satellite terminal that includes a GNSS receiver that uses information from the transcoder output signal.

19. The method of claim 18 wherein a second of the position and timing systems includes a LEO modem that requires a GNSS input.

20. The method of claim 18 further comprises sending, using a splitter coupled to the PNT system, the transcoder output signal, to GNSS receiver in the ACU and the LEO modem.
